(19) United States
(12) Patent Application Publication
(10) Pub. No.: US 2026/0355056 A1
(43) Pub. Date: Nov. 12, 2026

(54) MOXIBUSTION DEVICE WITH AUTOMATIC IGNITION FUNCTION

(71) Applicants: ZHEJIANG JUNCONTROL INTELLIGENT TECHNOLOGY CO., LTD., Jiaxing (CN); X-PENNY INC, COLUMBIA, MD (US)

(72) Inventors: YINXIN LI, Shanghai (CN); MENGEN HU, Shangqiu (CN); HUALEI PENG, Lianyungang (CN); SHIQIANG ZHENG, Ankang (CN); CANJUAN ZHANG, Heze (CN); PENGCAN FAN, Shanghai (CN); MINGRUI WANG, Wuchang (CN); BIN ZHANG, Shanghai (CN)

(21) Appl. No.: 19/720,650

(22) Filed: Jun. 25, 2026

(30) Foreign Application Priority Data
Apr. 24, 2026 (CN) 202620566590.2

(51) Int. Cl. A61H 39/06

(52) U.S. Cl. CPC A61H 39/06; A61H 2201/0207; A61H 2201/0228; A61H 2201/0278

(57) ABSTRACT

Provided is a moxibustion device with automatic ignition function, which includes a detachable ignition component configured to ignite a to-be-ignited object. The ignition component includes a heating wire provided below the to-be-ignited object. The heating wire includes small bending parts and large bending parts. The small bending parts are provided in an outer circumferential area of the to-be-ignited object for heating the outer circumferential area of the to-be-ignited object. The large bending parts extend to a center of the to-be-ignited object for heating an inner area of the center of the to-be-ignited object. The number of the small and large bending parts is adapted to a bottom surface area of the to-be-ignited object, so as to ensure that a proportion of a total heating area of the small and large bending parts covering the bottom surface area of the to-be-ignited object is greater than 80%.

### CROSS-REFERENCE TO RELATED APPLICATIONS

This application claims priority to Chinese Patent Application No. 202620566590.2 filed on Apr. 24, 2026, which is hereby incorporated by reference in its entirety.

### TECHNICAL FIELD

The present disclosure relates to the field of physical therapy device technologies, and in particular, to a moxibustion device with automatic ignition function.

### BACKGROUND

Moxibustion is a health preservation method with Chinese characteristics. It primarily uses moxa cones as the moxa material, which is ignited and then burned or warmed on acupoints on the body surface to achieve wellness purposes. The traditional approach involves lighting moxa cones using an open flame from a candle, alcohol lamp, lighter, or similar source. This method has several drawbacks: low efficiency, labor-intensive operation, risk of burns to the practitioner due to the open flame, and significant susceptibility to environmental factors such as air currents and ambient temperature. In the prior art, single-point electric arc igniters have been used to light moxa cones. Although these address the problems mentioned above, they still suffer from the following limitations:
(1) low ignition efficiency;
(2) smoke generated during ignition produces oily residue that adheres to the igniter, rendering it difficult to clean;
(3) uneven ignition of the moxa cone when using the electric arc; and
(4) due to the gap between the moxa cone and the electric arc, ignition efficiency remains affected by air currents and other external factors, resulting in poor wind resistance.

### SUMMARY

To solve the above problems, the technical solution provided by the present disclosure is a moxibustion device with automatic ignition function, including: an ignition component configured to ignite a to-be-ignited object, where the ignition component is detachably provided inside a therapy head, where the ignition component includes a heating wire that is provided below the to-be-ignited object; where the heating wire includes small bending parts and large bending parts, where the small bending parts are provided in an outer circumferential area of the to-be-ignited object configured to heat an outer circumferential area of the to-be-ignited object; the large bending parts are connected to the small bending parts and extend to a center of the to-be-ignited object and configured to heat an inner area of the center of the to-be-ignited object; the number of the small and large bending parts is adapted to a bottom surface area of the to-be-ignited object, so as to ensure that a proportion of a total heating area of the small and large bending parts covering the bottom surface area of the to-be-ignited object is greater than 80%; where the ignition component is fixedly provided inside a placement cylinder, and the placement cylinder is detachably connected to a smoking chamber of the therapy head.

In some embodiments of the present disclosure, the small bending parts and the large bending parts are arranged alternately; resistances of the small bending parts are the same as those of the large bending parts, or resistances of the small bending parts are greater than those of the large bending parts, or the resistances of the small bending parts are less than those of the large bending parts.

In some embodiments of the present disclosure, the small bending parts are serpentine bending and heating wire areas formed by bending along the outer circumferential area of the to-be-ignited object; the large bending parts are bending heating wire areas that extend along the small bending parts towards an axle centre of the to-be-ignited object.

In some embodiments of the present disclosure, a heating wire bracket is provided to one side of the heating wire away from the to-be-ignited object, and the heating wire bracket is configured to support the heating wire; the heating wire bracket is made of metal material and has an insulation and heat-resistant coating on a surface of the heating wire bracket.

In some embodiments of the present disclosure, the heating wire bracket includes a fixing sheet and a fixing ring, and the fixing sheet is configured to fix the heating wire and electrode sheet to a base.

In some embodiments of the present disclosure, the electrode sheet contacts a stationary electrode, and one side of the stationary electrode in contact with the electrode sheet extends outward to form a protrusion, the electrode sheet includes at least one elastic section and a contact end, the contact end is in contact with the protrusion and is conductive, the elastic section is connected to the contact end and provides elastic support force during a relative displacement between the contact end and the protrusion, so that the contact end slides along a surface of the protrusion; the stationary electrode is provided in a corresponding area on the fixing shell, so that when the placement cylinder is connected to the fixing shell, the stationary electrode and the electrode sheet are in contact and conductive, where the electrode sheet further includes a fixing end, and the fixing end is fixedly connected to the heating wire through an installation hole, and the fixing end is fixedly connected to the elastic section.

In some embodiments of the present disclosure, the heating wire bracket includes a fixing sheet and a fixing ring, where the fixing ring is provided with several support bars, and the number and shape of the support bars are adapted to the number and shape of the large bending parts to support the large bending parts; the shape and size of the fixing ring are adapted to the small bending parts and a circumferential shape of the to-be-ignited object to support the small bending parts; the fixing sheet is also connected with a connection strip, and the connection strip is fixedly connected to the support bars to form a tensile force on the support bars; where two ends of the heating wire formed by the small and large bending parts are provided with locking holes; one side of the fixing sheet is fixed to the heating wire through the locking holes, and the other side of the fixing sheet is fixed to the electrode sheet; both the fixing sheet and the electrode sheet are provided with threaded holes, and the threaded holes correspond to the locking holes for fixing, thereby sequentially fixing the heating wire, the fixing sheet, and the electrode sheet on the base.

In some embodiments of the present disclosure, it further includes the base, and the base is provided with a protective mesh, a support column, and an ash-removing member; the support column is fixedly connected to a fixing hole on the fixing ring and supports the heating wire bracket; the ash-removing member is provided at a lower end of the heating wire bracket and is arranged to be staggered with the heating wire bracket.

In some embodiments of the present disclosure, the elastic section is directly connected to the contact end or connected through a connection section, and the connection section is configured to increase a torque by providing a distance between the elastic section and the contact end; a cross-sectional shape of a contact surface between the protrusion and the contact end is circular arc; the elastic section is a rigid elastic sheet that generates rebound elasticity through bending, and an angle of a deformation zone of the bending is 20 degrees to 60 degrees; a curvature range of an arc-shaped cross-section of the protrusion is K1=0-1, a curvature range of an arc-shaped cross-section of the contact end is K2≤0.5, and a R angle of a contact area of the contact end is greater than or equal to 2 mm.

Beneficial effects: compared with the existing technology, the technical solution provided by the present disclosure has the following beneficial effects.

By providing several small and large bending parts, and heating the outer circumferential and central areas of the to-be-ignited object simultaneously, the ignition area is larger and more uniform, which can quickly ignite the to-be-ignited object and make it burn evenly. Compared with traditional arc ignition, it has higher efficiency and better effects.

### BRIEF DESCRIPTION OF DRAWINGS

FIG. 1 is an overall structural schematic diagram of a moxibustion device with automatic ignition function.

FIG. 2 is a structural schematic diagram after an ignition component being separated from a therapy head.

FIG. 3 is a structural schematic diagram in which the ignition component, a placement cylinder, and a fixing shell being connected.

FIG. 4 is a structural schematic diagram of the ignition component connected to the placement cylinder and a bracket.

FIG. 5 is a partial structural schematic diagram of the ignition component.

FIG. 6 is a first structural schematic diagram of a connection state between an electrode sheet and a stationary electrode.

FIG. 7 is a second structural schematic diagram of the connection state between the electrode sheet and the stationary electrode.

FIG. 8 is a structural schematic diagram of the electrode sheet.

FIG. 9 is a structural schematic diagram of a connection state of a heating wire and a heating wire bracket.

FIG. 10 is a structural schematic diagram of the heating wire.

FIG. 11 is a structural schematic diagram of the heating wire bracket.

FIG. 12 is a structural schematic diagram of the ignition component.

Numeral reference: 100—therapy head, 110—fixing shell, 120—smoke exhaust pipe, 130, 200—ignition component, 210—base, 220—heating wire bracket, 221—fixing sheet, 222—fixing ring, 223—fixing hole, 224—support bar, 225—connection strip, 230—ash-removing member, 240—heating wire, 241—locking hole, 242—small bending part, 243—large bending part, 250—support column, 260—electrode sheet, 261—fixing end, 262—installation hole, 263—elastic section, 264—connection section, 265—contact end, 270—protective mesh, 280—stationary electrode, 281—clamp connection end, 282—recess, 283—through hole, 284—inclined surface, 285—protrusion, 310—bracket, 320—placement cylinder, 400—to-be-ignited object.

### DESCRIPTION OF EMBODIMENTS

In order to enable those skilled in the art to better understand the technical solution of the present application, the following will provide a clear and complete description of the technical solution in the embodiments of the present application in combination with the accompanying drawings. Obviously, the embodiments described are only a part of the embodiments of the present application, not all of them. Based on the embodiments in the present application, all other embodiments obtained by those skilled in the art without creative work should fall within the protection scope of the present application.

It should be noted that terms “first”, “second”, etc. in the specification and claims of the present application, as well as in the accompanying drawings, are used to distinguish similar objects and do not necessarily need to be used to describe a specific order or sequence. It should be understood that data used in this way can be interchanged in appropriate circumstances for the embodiments described herein. In addition, the terms “including” and “comprising”, as well as any variations thereof, are intended to cover non-exclusive inclusions, such as processes, methods, systems, products, or devices that contain a series of steps or units that are not necessarily limited to those clearly listed, but may include other steps or units that are not clearly listed or inherent to these processes, methods, products, or devices.

In the present application, terms “up”, “down”, “left”, “right”, “front”, “back”, “top”, “bottom”, “inside”, “outside”, “center”, “vertical”, “horizontal”, “transverse”, “longitudinal”, etc. indicate orientation or positional relationships based on the orientation or positional relationships shown in the accompanying drawings. These terms are mainly used to better describe the present application and the embodiments, and are not intended to limit that the indicated device, element, or component must have a specific orientation or be constructed and operated in a specific orientation.

And, in addition to being used to represent orientation or positional relationships, some of the above terms may also be used to represent other meanings, such as the term “up” being used in some cases to represent some kind of attachment or connection relationship. For those skilled in the art, they can understand the specific meanings of these terms in the present application according to the specific situation.

Furthermore, terms “installation”, “arranging”, “providing”, “connection to”, “connection with”, and “sleeving with” should be broadly understood. For example, it can be a fixed connection, a detachable connection, or a monolithic structure, it can be a mechanical connection or an electrical connection, it can be directly connected, indirectly connected through an intermediate medium, or internally connected between two devices, components, or parts. For those skilled in the art, specific meanings of the above terms in the present application can be understood according to the specific situation.

It should be noted that the embodiments and features in the embodiments of the present application can be combined with each other without conflict. Below, the present application will be described in detail with reference to the accompanying drawings and in combination with embodiments.

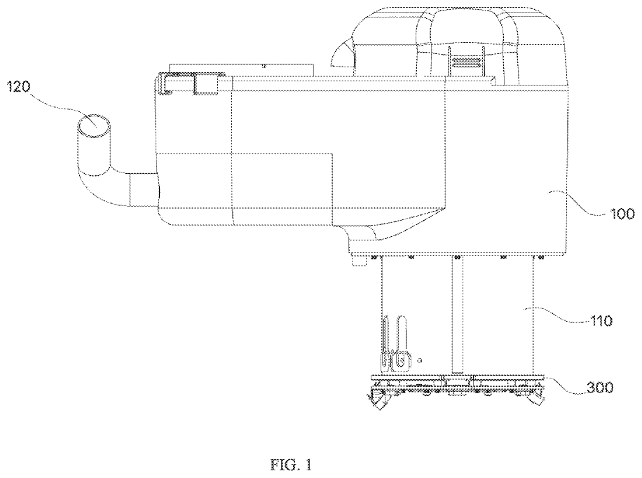

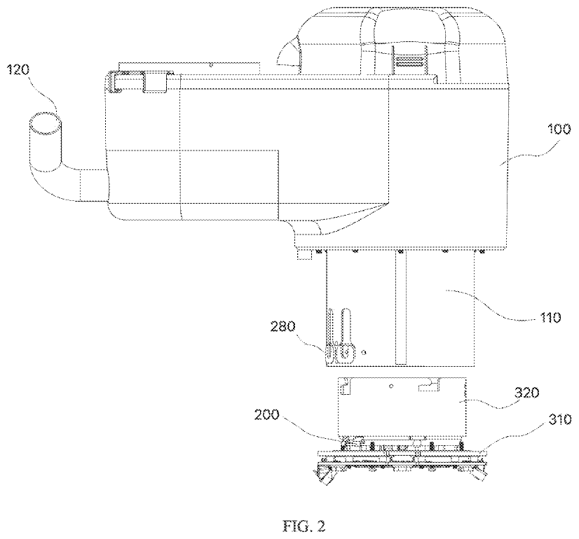

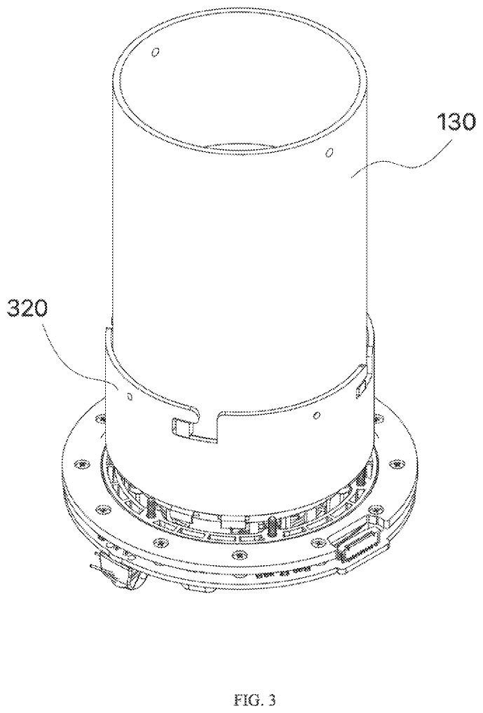

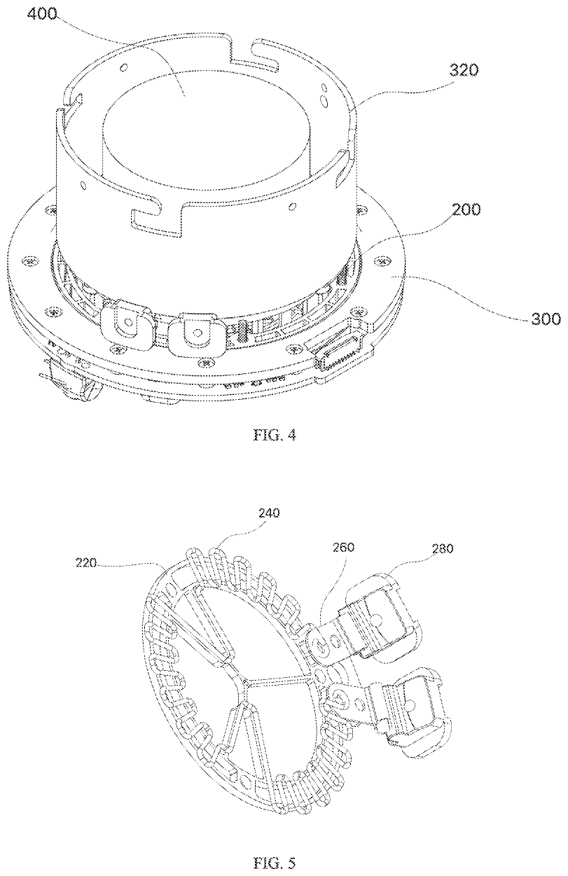

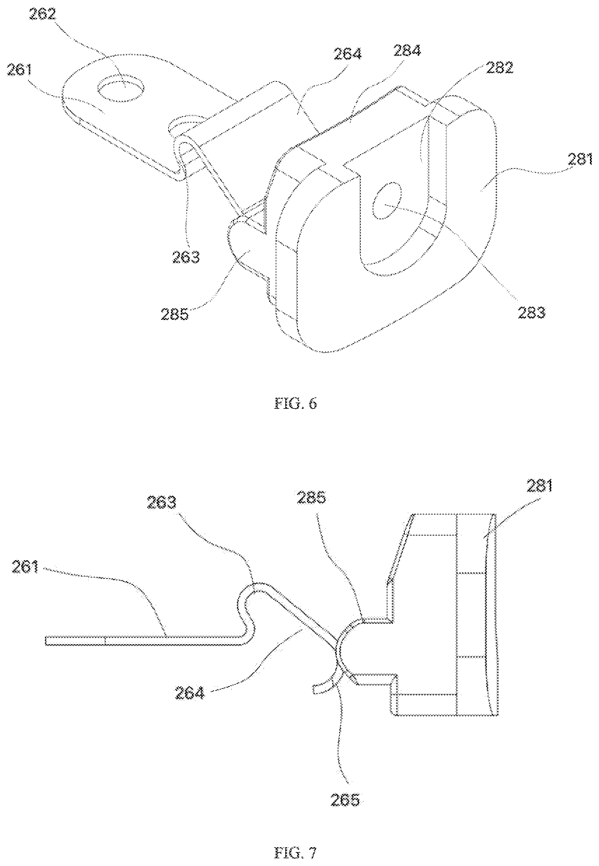

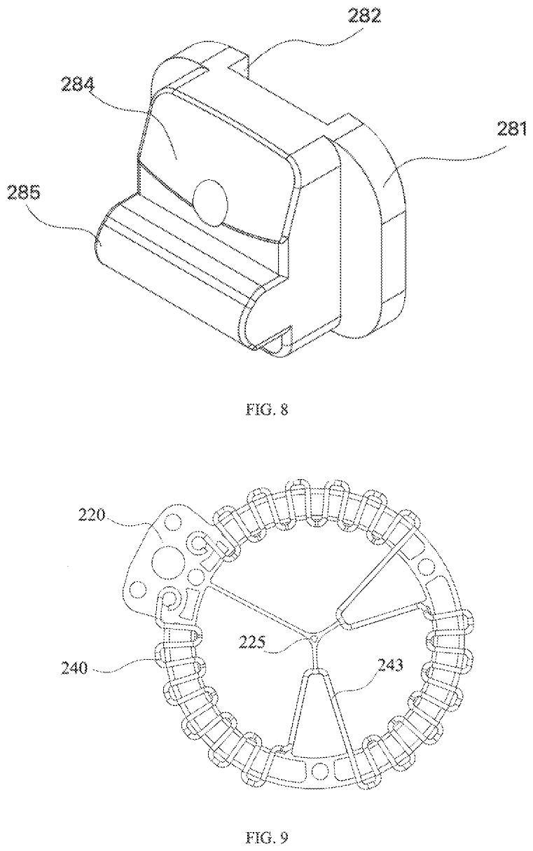

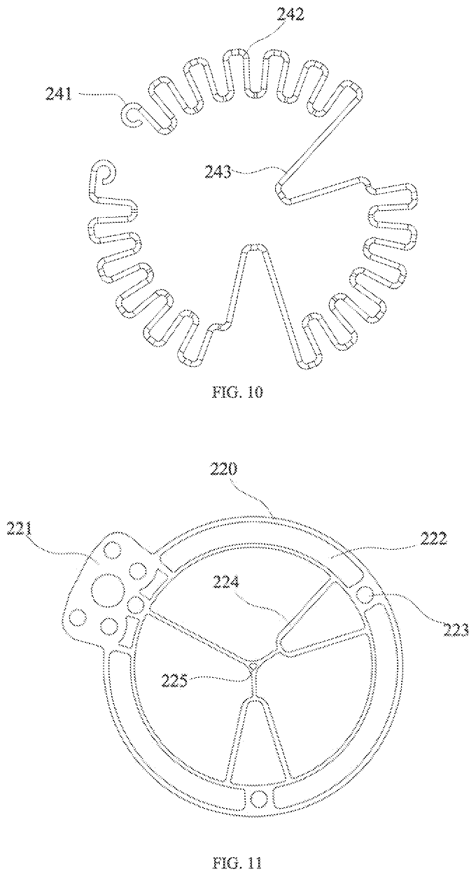

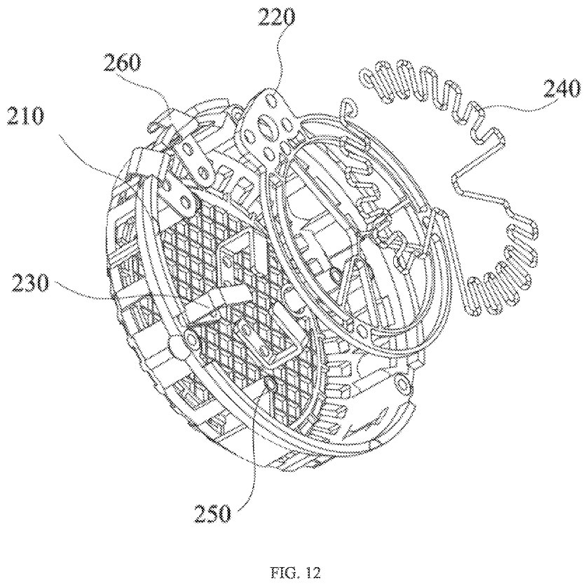

Referring to FIGS. 1-12, a moxibustion device with automatic ignition function in this embodiment includes an ignition component 200 that can be detachably installed inside a therapy head 100 and is configured to ignite a to-be-ignited object 400. The ignition component 200 includes a heating wire 240 that is provided below the to-be-ignited object 400. The heating wire 240 includes small bending parts 242 and large bending parts 243. The small bending parts 242 are provided in an outer circumferential area of the to-be-ignited object 400 and is configured to heat an outer circumferential area of the to-be-ignited object 400, the large bending parts 243 are connected to the small bending parts 242 and extend to a center of the to-be-ignited object 400 configured to heat an inner area of the center of the to-be-ignited object 400. The number of the small bending parts 242 and large bending parts 243 is adapted to a bottom surface area of the to-be-ignited object 400, so as to ensure that a proportion of a total heating area of the small bending parts 242 and large bending parts 243 that cover the bottom surface area of the to-be-ignited object 400 is more than 80%. The to-be-ignited object 400 is moxa cones or other combustion therapy materials. By providing several small bending parts 242 and large bending parts 243, and heating the outer circumferential and central areas of the to-be-ignited object simultaneously, the ignition area is larger and more uniform, which can quickly ignite the to-be-ignited object 400 and make it burn evenly. Compared with traditional arc ignition, it has higher efficiency and better effect.

The small bending parts 242 and the large bending parts 243 are arranged alternately, so that the small bending parts 242 and the large bending parts 243 can more evenly contact the bottom surface of the to-be-ignited object 400, thereby promoting the ignition effect.

The resistances of the small bending parts 242 are the same as those of the large bending parts 243, or the resistances of the small bending parts 242 are greater than those of the large bending parts 243, or the resistances of the small bending parts 242 are less than those of the large bending parts 243. The small bending parts 242 and the large bending parts 243 with different resistors can be configured according to the different igniting materials, so as to achieve better heating and ignition.

The small bending parts 242 are serpentine bending and heating wire areas formed by bending along the outer circumferential area of the to-be-ignited object 400, the large bending parts 243 are bending heating wire areas that extend along the small bending parts 242 towards an axle centre of the to-be-ignited object 400. The shapes of the large bending parts 243 can be V-shaped, U-shaped, N-shaped, M-shaped, zigzag shaped, or other shapes can be bending to expand the heating area.

A heating wire bracket 220 is provided at one side of the heating wire 240 away from the to-be-ignited object 400, and the heating wire bracket 220 is configured to support the heating wire 240. The heating wire bracket 220 includes a fixing sheet 221 and a fixing ring 222. The fixing sheet 221 is configured to fix the heating wire 240 and an electrode sheet 260 to a base 210.

The heating wire bracket 220 includes the fixing sheet 221 and the fixing ring 222. The fixing ring 222 is provided with several support bars 224, and the number and shape of the support bars 224 are adapted to the number and shape of the large bending parts 243 to support the large bending parts 243, the shape and size of the fixing ring 222 are adapted to the small bending parts 242 and a circumferential shape of the to-be-ignited object 400 to support the small bending parts 242. The fixing sheet 221 is also connected to a connection strip 225, and the connection strip 225 is fixedly connected to the support bars 224 to form a tensile force on the support bars 224.

Two ends of the heating wire 240 formed by the small bending parts 242 and the large bending parts 243 are provided with locking holes 241. One side of the fixing sheet 221 is fixed to the heating wire 240 through the locking holes 241, and the other side of the fixing sheet 221 is fixed to the electrode sheet 260. Both the fixing sheet 221 and the electrode sheet 260 are provided with threaded holes, and the threaded holes correspond to the locking holes 241 for fixing, thereby sequentially fixing the heating wire 240, the fixing sheet 221, and the electrode sheet 260 on the base 210.

The moxibustion device with automatic ignition function further includes the base 210, and the base 21 is provided with a protective mesh 270, a support column 250, and an ash-removing member 230. The support column 250 is fixedly connected to a fixing hole 223 on the fixing ring 222 to support the heating wire bracket 220. The ash-removing member 230 is provided at a lower end of the heating wire bracket 220 and is arranged to be staggered with the heating wire bracket 220. The ash-removing member 230 is fixedly connected to the protective mesh 270, and the protective mesh 270 is movably provided inside the base 210 and can move up and down inside the base 210. A lower end of the protective mesh 270 can be provided with a lifting or telescopic device to drive the protective mesh 270 and the ash-removing member 230 to move upward, so that the ash-removing member 230 can contact the to-be-ignited object 400 and perform a sweeping ash operation.

A power supply voltage connected to electrode sheet 260 is 12-220V. A heating power of the heating wire 240 is adapted to the power supply voltage to enable the automatic ignition device of this embodiment to operate at low voltage, preventing damage to the human body caused by conventional high voltage in case of faults.

The heating wire bracket 220 is made of metal material and has an insulation and heat-resistant coating on its surface. The heating wire bracket 220 can provide good support for the heating wire 240 and provide insulation and heat insulation. The insulation and heat-resistant coating is a compound coating known in the prior art that has insulation and heat insulation effects.

The electrode sheet 260 is in contact with a stationary electrode 280, and the stationary electrode 280 is arranged in a corresponding area on a fixing shell 110 when a placement cylinder 320 is connected to the fixing shell 110, the stationary electrode 280 and the electrode sheet 260 are in contact and conductive; one side of the stationary electrode 280 in contact with the electrode sheet 260 extends outward to form a protrusion 285. The electrode sheet 260 includes at least one elastic section 263 and a contact end 265. The contact end 265 is in contact with the protrusion 285 and is conductive. The elastic section 263 is connected to the contact end 265 and provides elastic support force during a relative displacement between the contact end 265 and the protrusion 285, so that the contact end 265 slides along a surface of the protrusion 285. The stationary electrode 280 is provided on a moxibustion head, and the electrode sheet 260 is connected to the heating wire 240 provided on the ignition device. When ignition is required, the ignition device is provided on the moxibustion head. During the up and down movement and connection of the stationary electrode 280 and the electrode sheet 260, the electrode sheet 260 will cross the surface of the protrusion 285 of the stationary electrode 280, thereby removing the dirt attached to an area that has been crossed by the electrode sheet 260 and ensuring effective conductivity between the stationary electrode 280 and the electrode sheet 260.

The electrode sheet 260 further includes a fixing end 261, and the fixing end 261 is fixedly connected to the heating wire 240 through an installation hole 262, and the fixing end 261 is fixedly connected to the elastic section 263.

The elastic section 263 is a conductive elastic connector or a rigid connector that generates rebound elasticity through bending. For example, it can be a conductive elastomer, a metal elastic contact, or a metal elastic thin sheet. In an implementation mode, the elastic section 263 is a rigid elastic sheet that generates rebound elasticity through bending, with an angle of a deformation zone being 20 degrees to 60 degrees during bending.

The elastic section 263 is directly connected to the contact end 265 or connected through a connection section 264, and the connection section 264 is configured to increase a torque by providing a certain distance between the elastic section 263 and the contact end 265. To ensure that the contact force between the contact end 265 and the protrusion 285 is sufficient to remove the dirt on the surface of the protrusion 285.

A curvature range of an arc-shaped cross-section of the protrusion 285 is K1=0-1. A curvature range of an arc-shaped cross-section of the contact end 265 is K2≤0.5. A R angle of a contact area of the contact end 265 is greater than or equal to 2 mm. This allows for a sufficiently large contact surface between the protrusion 285 and the contact end 265, which can remove the dirt from the surface of the protrusion 285 as much as possible.

The stationary electrode 280 further includes a clamp connection end 281 with a recess 282, and a through hole 283 is provided inside the recess 282 for connecting and power supply. The clamp connection end 281 is configured to connect a to-be-installed workpiece; the protrusion 285 is provided on the other side of the clamp connection end 281 relative to the recess 282, and the clamp connection end 281 have an inclined surface 284 for yielding in an area adjacent to the protrusion 285 on one side of the protrusion 285.

The ignition component 200 is fixedly provided inside the placement cylinder 320, and the placement cylinder 320 can be detachably connected to the ignition component 130 of the therapy head 100. The therapy head 100 also has a smoke exhaust pipe 120 communicated to a combustion chamber, and the combustion chamber is a space formed by a connection between the placement cylinder 320 and the ignition component 130.

In an implementation mode, the placement cylinder 320 and the ignition component 130 can be connected by easily detachable means such as threads, buckles, magnetic suction, etc.

The above embodiments only express some embodiments of the present disclosure, and their descriptions are more specific and detailed, but should not be understood as limiting the scope of the present disclosure. It should be noted that for those skilled in the art, several modifications and improvements can be made without departing from the inventive concept, which are within the protection scope of the present disclosure; therefore, the protection scope of the present disclosure should be based on the appended claims.

What is claimed is:

1. A moxibustion device with automatic ignition function, comprising: an ignition component configured to ignite a to-be-ignited object, wherein the ignition component is detachably provided inside a therapy head,
wherein the ignition component comprises a heating wire that is provided below the to-be-ignited object;
wherein the heating wire comprises small bending parts and large bending parts, wherein the small bending parts are provided in an outer circumferential area of the to-be-ignited object configured to heat the outer circumferential area of the to-be-ignited object;
the large bending parts are connected to the small bending parts and extend to a center of the to-be-ignited object and configured to heat an inner area of the center of the to-be-ignited object;
the number of the small and large bending parts is adapted to a bottom surface area of the to-be-ignited object, so as to ensure that a proportion of a total heating area of the small and large bending parts covering the bottom surface area of the to-be-ignited object is greater than 80%;
wherein the ignition component is fixedly provided inside a placement cylinder, and the placement cylinder is detachably connected to a smoking chamber of the therapy head.

2. The moxibustion device with automatic ignition function according to claim 1, wherein the small bending parts and the large bending parts are arranged alternately; resistances of the small bending parts are the same as those of the large bending parts, or the resistances of the small bending parts are greater than those of the large bending parts, or the resistances of the small bending parts are less than those of the large bending parts.

3. The moxibustion device with automatic ignition function according to claim 1, wherein the small bending parts are serpentine bending and heating wire areas formed by bending along the outer circumferential area of the to-be-ignited object; the large bending parts are bending heating wire areas that extend along the small bending parts towards an axle centre of the to-be-ignited object.

4. The moxibustion device with automatic ignition function according to claim 1, wherein a heating wire bracket is provided to one side of the heating wire away from the to-be-ignited object, and the heating wire bracket is configured to support the heating wire;
the heating wire bracket is made of metal material and has an insulation and heat-resistant coating on a surface of the heating wire bracket.

5. The moxibustion device with automatic ignition function according to claim 4, wherein the heating wire bracket comprises a fixing sheet and a fixing ring, and the fixing sheet is configured to fix the heating wire and an electrode sheet to a base.

6. The moxibustion device with automatic ignition function according to claim 4, wherein the electrode sheet contacts a stationary electrode, and one side of the stationary electrode that faces the electrode sheet extends outward to form a protrusion, the electrode sheet comprises at least one elastic section and a contact end, wherein the contact end contacts and is conductively coupled to the protrusion,
the elastic section is connected to the contact end and provides elastic support force during a relative displacement between the contact end and the protrusion, so that the contact end slides along a surface of the protrusion; the stationary electrode is provided in a corresponding area on the fixing shell, so that when the placement cylinder is connected to the fixing shell, the stationary electrode and the electrode sheet are in contact and conductive,
wherein the electrode sheet further comprises a fixing end, and the fixing end is fixedly connected to the heating wire through an installation hole, and the fixing end is fixedly connected to the elastic section.

7. The moxibustion device with automatic ignition function according to claim 6, wherein the heating wire bracket comprises a fixing sheet and a fixing ring,
wherein the fixing ring is provided with several support bars, and the number and shape of the support bars are adapted to the number and shape of the large bending parts to support the large bending parts;
the shape and size of the fixing ring are adapted to the small bending parts and a circumferential shape of the to-be-ignited object to support the small bending parts;
the fixing sheet is also connected with a connection strip, and the connection strip is fixedly connected to the support bars to form a tensile force on the support bars;
wherein two ends of the heating wire formed by the small and large bending parts are provided with locking holes; one side of the fixing sheet is fixed to the heating wire through the locking holes, and the other side of the fixing sheet is fixed to the electrode sheet;
both the fixing sheet and the electrode sheet are provided with threaded holes, and the threaded holes correspond to the locking holes for fixing, thereby sequentially fixing the heating wire, the fixing sheet, and the electrode sheet on the base.

8. The moxibustion device with automatic ignition function according to claim 7, wherein it further comprises the base, and the base is provided with a protective mesh, a support column, and an ash-removing member;
the support column is fixedly connected to a fixing hole on the fixing ring and supports the heating wire bracket; the ash-removing member is provided at a lower end of the heating wire bracket and is arranged to be staggered with the heating wire bracket.

9. The moxibustion device with automatic ignition function according to claim 8, wherein the elastic section is directly connected to the contact end or connected through a connection section, and the connection section is configured to increase a torque by providing a distance between the elastic section and the contact end; a cross-sectional shape of a contact surface between the protrusion and the contact end is circular arc;
the elastic section is a rigid elastic sheet that generates rebound elasticity through bending, and an angle of a deformation zone of the bending is 20 degrees to 60 degrees; a curvature range of an arc-shaped cross-section of the protrusion is K1=0-1, a curvature range of an arc-shaped cross-section of the contact end is K2≤0.5, and a R angle of a contact area of the contact end is greater than or equal to 2 mm.
